(19) United States
(12) Patent Application Publication
(10) Pub. No.: US 2020/0257296 A1
(43) Pub. Date: Aug. 13, 2020

(54) PLAN BUFFERING FOR LOW-LATENCY POLICY UPDATES

(71) Applicant: Samsung Electronics Co., Ltd., Suwon-si (KR)

(72) Inventors: Peng Liu, San Jose, CA (US); Brian Paden, San Jose, CA (US)

(21) Appl. No.: 16/274,026

(22) Filed: Feb. 12, 2019

(51) Int. Cl. G05D 1/02; G05B 19/042; G05D 1/00

(52) U.S. Cl. CPC G05D 1/0212; G05B 19/042; G05D 2201/0213; G05B 2219/2637; G05D 1/0088

(57) ABSTRACT

In one embodiment, a system includes a processor; and a memory coupled to the processor to store instructions, which when executed by the processor, cause the processor to perform operations, the operations including: receiving perception data; calculating a first reference trajectory based on the perception data, the first reference trajectory scheduled to be executed at a start time; and generating, before the start time, a first control policy based on the first reference trajectory.

### FIELD

The present technology is generally related to devices and methods for low-latency policy updates, more particularly, to a low-latency method of implementing a control policy for autonomously controlling a moving system.

### BACKGROUND

Most autonomous systems partition the selection of actions at each instant into motion planning and motion tracking control. There is a separation of timescales between these two decision-making processes that makes the interprocess communication a nontrivial engineering task. In particular, upon arrival of a new reference trajectory determining the motion of an autonomous moving system (e.g., an autonomous vehicle) for a future time, the reference trajectory is processed to determine a control policy for tracking the reference trajectory. This processing phase can introduce latency in the reaction time of the vehicle. A new approach to the reference trajectory message handling by the autonomous system that reduces or eliminates this latency is desired.

### SUMMARY

The techniques of this disclosure generally relate to low latency implementation of control policy for autonomously controlling a vehicle.

In one aspect, the control policy is computed prior to insertion into a message buffer rather than after which allows for a low latency switch from a stale policy to a more recent one in the buffer.

The details of one or more aspects of the disclosure are set forth in the accompanying drawings and the description below. Other features, objects, and advantages of the techniques described in this disclosure will be apparent from the description and drawings, and from the claims.

According to at least one embodiment, a system comprises: a processor; and a memory coupled to the processor to store instructions, which when executed by the processor, cause the processor to perform operations, the operations including: receiving perception data; calculating a first reference trajectory based on the perception data, the first reference trajectory scheduled to be executed at a start time; and generating, before the start time, a first control policy based on the first reference trajectory.

According to at least one further embodiment, a computer-implemented method for operating an autonomous moving system comprises: receiving perception data; calculating a first reference trajectory based on the perception data, the first reference trajectory scheduled to be executed at a start time; and generating, before the start time, a first control policy based on the first reference trajectory.

According to at least one further embodiment, a non-transitory machine-readable medium having instructions stored therein, when executed by a processor, cause the processor to perform operations, the operations comprising: receiving perception data; calculating a first reference trajectory based on the perception data, the first reference trajectory scheduled to be executed at a start time; and generating, before the start time, a first control policy based on the first reference trajectory.

### BRIEF DESCRIPTION OF DRAWINGS

FIG. 1 is a block diagram illustrating an autonomous moving system network configuration according to one embodiment.

FIG. 2 is a block diagram illustrating an example of an autonomous moving system according to one embodiment.

FIG. 3 is a block diagram illustrating an example of a perception and planning system used with an autonomous moving system according to one embodiment.

FIG. 4 illustrates a block diagram of a basic system architecture implementing a planning and control process.

FIG. 5 illustrates a timeline of reference trajectories and control policies generated in a conventional approach introducing latency.

FIG. 6 illustrates a timeline of reference trajectories and control policies generated in an embodiment of the present inventive concept reducing latency.

FIG. 7 depicts a timeline of reference trajectories and control policies generated in a conventional approach introducing latency.

FIG. 8 illustrates a low-latency process of calculating and selecting up-to-date policies.

FIG. 9 is a flow diagram illustrating a low-latency process of calculating and selecting up-to-date policies.

FIG. 10 is a block diagram illustrating control policies in a policy buffer.

### DETAILED DESCRIPTION

In one aspect, the inventive concept reduces latency in the motion planning and motion tracking process for autonomous moving systems. In one embodiment, this latency reduction is achieved by computing control policy immediately after receiving a reference trajectory from a motion planner, without waiting for the reference trajectory to become valid for execution. The autonomous system selects a more up-to-date control policy stored in the policy buffer. Control commands are generated based on the more-up-to-date control policy in the buffer.

A “moving system,” as used herein, refers to any computerized system with a physical moving part and is not necessarily limited to a system that moves from one geographic location to another. For example, an industrial robot that is an articulated robot with joints may constitute a moving system, even if it operates in place and does not travel from one geographic location to another. For clarity of illustration, examples here include an autonomous vehicle that moves from one geographic location to another. However, this is not a limitation of the inventive concept.

In a system for an autonomous moving system, a planner (a.k.a. a motion planner) implementing a planning process is responsible for reasoning about the free space in a scene and selecting a reference trajectory over a time interval, while a controller implementing a control process is responsible for selecting the appropriate actions (steering, throttle, etc.) to be performed by the moving system in order to track the trajectory selected by the planner. This requires careful coordination between the planner and the controller, especially when the planner updates the reference trajectory and the controller selects a new control policy for the new motion while transitioning from one to the other as seamlessly as possible.

In the context of this disclosure, “online” means computations performed by the computing system as the autonomous moving system operates (e.g. as the autonomous moving system moves).

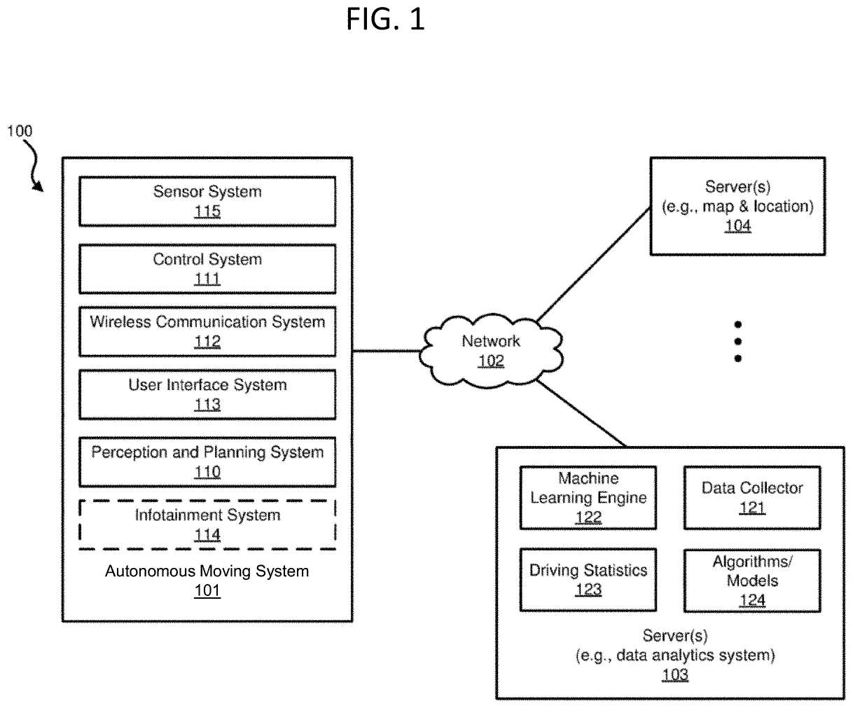

FIG. 1 is a block diagram illustrating an autonomous moving system network configuration according to one embodiment. Referring to FIG. 1, network configuration 100 includes autonomous moving system 101 that may be communicatively coupled to one or more servers 103-104 over a network 102. Although there is one autonomous moving system shown, multiple autonomous moving systems can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) severs, or location servers, etc. In the embodiment of FIG. 1, server 103 includes machine learning engine 122, data collector 121, driving statistics 123 and algorithms and models 124, such as finite state machines (FSMs). The FSMs can be utilized to determine a status or state of an autonomous moving system. In a non-limiting example, the autonomous moving system 101 may be a vehicle. Based on the state or status of the vehicle, a reference trajectory can be selected to drive the vehicle. A reference trajectory may include sufficient information regarding how to plan and control the vehicle for a limited future interval, particularly in view of prior driving experiences or driving statistics of the vehicle under the same or similar driving environment.

As stated above, autonomous moving system 101 may be an autonomous vehicle, in a non-limiting example. An autonomous vehicle refers to a vehicle that can be configured to in an autonomous mode in which the vehicle navigates through an environment with little or no input from a driver. Such an autonomous vehicle can include a sensor system having one or more sensors that are configured to detect information about the environment in which the vehicle operates. The vehicle and its associated controller(s) use the detected information to navigate through the environment. An autonomous vehicle can operate in a manual mode, a full autonomous mode, or a partial autonomous mode.

In one embodiment, autonomous moving system 101 includes, but is not limited to, perception and planning system 110, control system 111, wireless communication system 112, user interface system 113, infotainment system 114, and sensor system 115. Autonomous moving system 101 may further include certain common components included in ordinary vehicles, such as an engine, wheels, steering wheel, transmission, etc., which may be controlled by control system 111 and/or perception and planning system 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

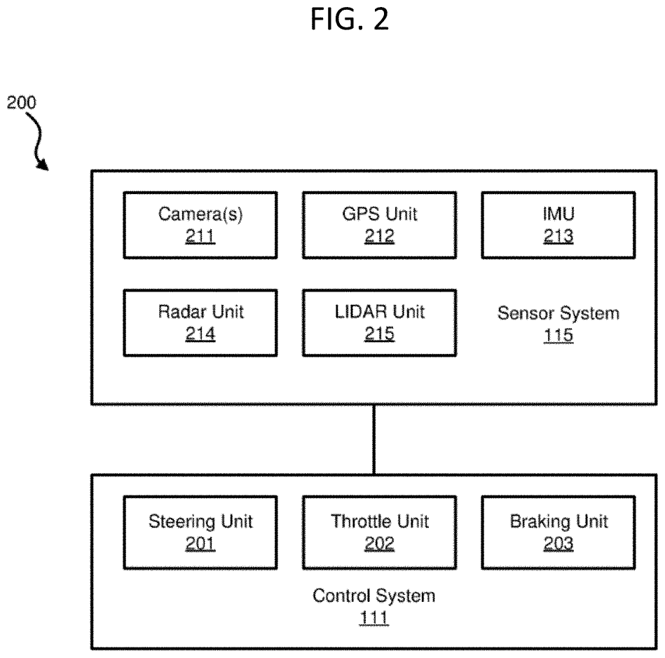

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the autonomous moving system. IMU unit 213 may sense position and orientation changes of the autonomous moving system based on inertial acceleration. Radar unit 214 may represent a system that utilizes radio signals to sense objects within the local environment of the autonomous moving system. In some embodiments, in addition to sensing objects, radar unit 214 may additionally sense the speed and/or heading of the objects. LIDAR unit 215 may sense objects in the environment in which the autonomous moving system is located using lasers. LIDAR unit 215 could include one or more laser sources, a laser scanner, and one or more detectors, among other system components. Cameras 211 may include one or more devices to capture images of the environment surrounding the autonomous moving system. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous moving system. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn control the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between autonomous moving system 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within autonomous moving system 101), for example, using an infrared link, Bluetooth, etc. User interface system 113 may be part of peripheral devices implemented within autonomous moving moving system 101 including, for example, a keyword, a touch screen display device, a microphone, and a speaker, etc.

Some or all of the functions of autonomous moving system 101 may be controlled or managed by perception and planning system 110, especially when operating in an autonomous driving mode. Perception and planning system 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive autonomous moving system 101 based on the planning and control information. Alternatively, perception and planning system 110 may be integrated with control system 111.

For example, a user as a passenger may specify a starting location and a destination of a trip, for example, via a user interface. Perception and planning system 110 obtains the trip related data. For example, perception and planning system 110 may obtain location and route information from an MPOI server, which may be a part of servers 103-104. The location server provides location services and the MPOI server provides map services and the POIs of certain locations. Alternatively, such location and MPOI information may be cached locally in a persistent storage device of perception and planning system 110.

While autonomous moving system 101 is moving along the route, perception and planning system 110 may also obtain real-time traffic information from a traffic information system or server (TIS). Note that servers 103-104 may be operated by a third party entity. Alternatively, the functionalities of servers 103-104 may be integrated with perception and planning system 110. Based on the real-time traffic information, MPOI information, and location information, as well as real-time local environment data detected or sensed by sensor system 115 (e.g., obstacles, objects, nearby vehicles), perception and planning system 110 can plan an optimal route and drive autonomous moving system 101, for example, via control system 111, according to the planned route to reach the specified destination safely and efficiently.

According to one embodiment, autonomous moving system 101 may further include infotainment system 114 to provide information and entertainment to passengers of autonomous moving system 101. The information and entertainment content may be received, compiled, and rendered based on content information stored locally and/or remotely (e.g., provided by servers 103-104). For example, the information may be streamed in real-time from any of servers 103-104 over network 102 and displayed on a display device of autonomous moving system 101. The information may be augmented with local information captured in real-time, for example, by one or more cameras and the augmented content can then be displayed in a virtual reality manner.

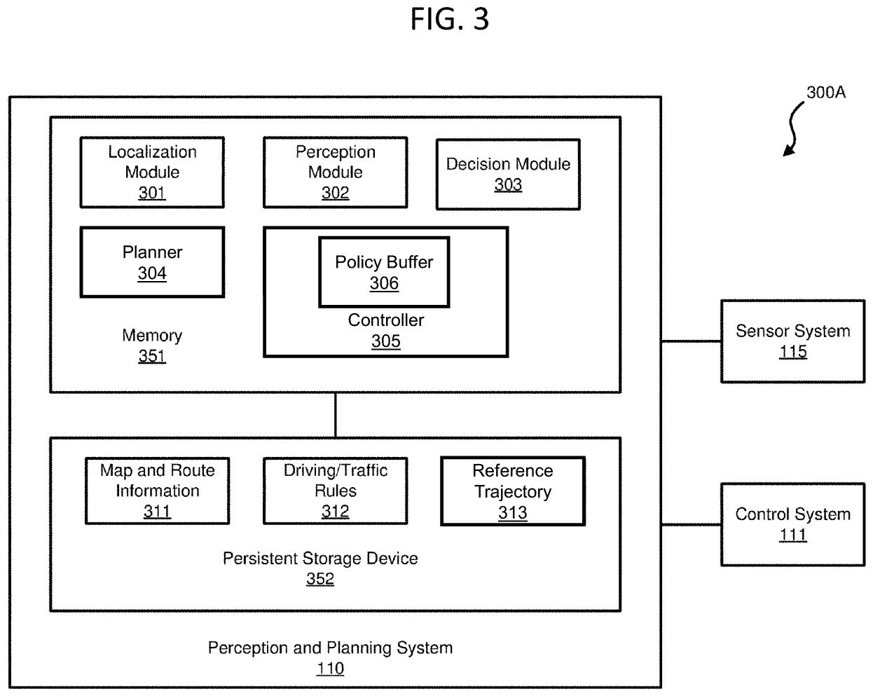

FIG. 3 is a block diagram illustrating an example of a perception and planning system used with an autonomous moving system according to one embodiment. System 300A may be implemented as a part of autonomous moving system 101 of FIG. 1 including, but is not limited to, perception and planning system 110, control system 111, and sensor system 115, and/or a combination thereof. Referring to FIG. 3, perception and planning system 110 includes, but is not limited to, localization module 301, perception module 302, decision module 303, planner 304, controller 305 including a policy buffer 306, map and route information 311, driving/traffic rules 312, and reference trajectory 313.

Some or all of modules 301-305 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of control system 111 of FIG. 2. Some of modules 301-305 may be integrated together as an integrated module.

Localization module 301 (also referred to as a map and route module) manages any data related to a trip or route of a user. A user may log in and specify a starting location and a destination of a trip, for example, via a user interface. Localization module 301 communicates with other components system 300A, such as map and route information 311, to obtain the trip related data. For example, localization module 301 may obtain location and route information from a location server and a map and POI (MPOI) server. A location server provides location services and an MPOI server provides map services and the POIs of certain locations, which may be cached as part of map and route information 311. While autonomous moving system 300 is moving along the route, localization module 301 may also obtain real-time traffic information from a traffic information system or server.

Based on the sensor data provided by sensor system 115 and localization status obtained by localization module 301, a perception of the surrounding environment is determined by perception module 302. The perception data may represent what an ordinary driver would perceive surrounding a vehicle in which the driver is driving. The perception can include the lane configuration (e.g., straight or curve lanes), traffic light signals, a relative position of another vehicle, a pedestrian, a building, crosswalk, or other traffic related signs (e.g., stop signs, yield signs), etc., for example, in a form of an object.

Perception module 302 may include a computer vision system or functionalities of a computer vision system to process and analyze images captured by one or more cameras in order to identify objects and/or features in the environment of autonomous moving system. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, decision module 303 makes a decision regarding how to handle the object. For example, for a particular object (e.g., another vehicle in a crossing route) as well as its metadata describing the object (e.g., a speed, direction, turning angle), decision module 303 decides how to encounter the object (e.g., overtake, yield, stop, pass). Decision module 303 may make such decisions according to a set of rules such as traffic rules, which may be stored in persistent storage device 352 (not shown).

Based on a decision for each of the objects perceived, planning module 304 plans a path or route for the autonomous moving system, as well as driving parameters (e.g., distance, speed, and/or turning angle). That is, for a given object, decision module 303 decides what to do with the object, while planner 304 determines how to do it. For example, for a given object, decision module 303 may decide to pass the object, while planner 304 may determine whether to pass on the left side or right side of the object. A reference trajectory 313 is generated by planner 304 including information describing how autonomous moving system 101 would move in a next moving cycle (e.g., next route/path segment). For example, the reference trajectory 313 may instruct autonomous moving system 101 to move 10 meters at a speed of 30 mile per hour (mph), then change to a right lane at the speed of 25 mph.

Based on the planning and control data, controller 305 controls and drives the autonomous moving system, by sending proper commands or signals to control system 111, according to a route or path defined by the planning and control data. The planning and control data include sufficient information to drive the vehicle from a first point to a second point of a route or path using appropriate vehicle settings or driving parameters (e.g., throttle, braking, and turning commands) at different points in time along the path or route.

Note that decision module 303 and planner 304 may be integrated as an integrated module. Decision module 303/planner 304 may include a navigation system or functionalities of a navigation system to determine a driving path for the autonomous moving system. For example, the navigation system may determine a series of speeds and directional headings to effect movement of the autonomous moving system along a path that substantially avoids perceived obstacles while generally advancing the autonomous moving system along a roadway-based path leading to an ultimate destination. The destination may be set according to user inputs via user interface system 113. The navigation system may update the driving path dynamically while the autonomous moving system is in operation. The navigation system can incorporate data from a GPS system and one or more maps so as to determine the driving path for the autonomous moving system.

Decision module 303/planner 304 may further include a collision avoidance system or functionalities of a collision avoidance system to identify, evaluate, and avoid or otherwise negotiate potential obstacles in the environment of the autonomous moving system. For example, the collision avoidance system may effect changes in the navigation of the autonomous moving system by operating one or more subsystems in control system 111 to undertake swerving maneuvers, turning maneuvers, braking maneuvers, etc. The collision avoidance system may automatically determine feasible obstacle avoidance maneuvers on the basis of surrounding traffic patterns, road conditions, etc. The collision avoidance system may be configured such that a swerving maneuver is not undertaken when other sensor systems detect vehicles, construction barriers, etc. in the region adjacent the autonomous moving system that would be swerved into. The collision avoidance system may automatically select the maneuver that is both available and maximizes safety of occupants of the autonomous moving system. The collision avoidance system may select an avoidance maneuver predicted to cause the least amount of acceleration in a passenger cabin of the autonomous moving system.

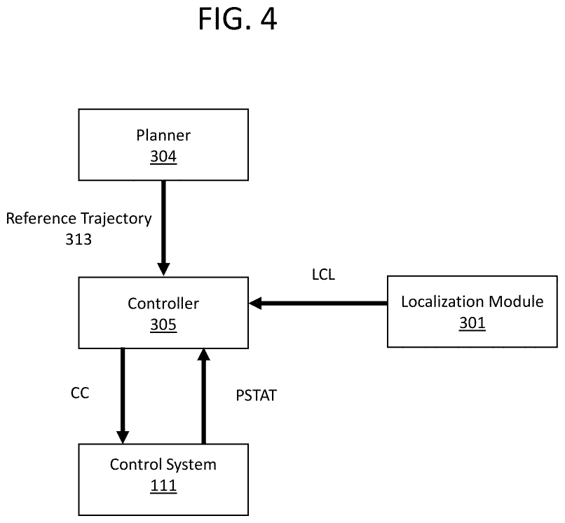

FIG. 4 illustrates a block diagram of a basic system architecture implementing a planning and control process.

The output from the planner 304 is reference trajectory 313 of the self-driving platform 200. The localization module 301 and the control system 111 respectively provide localization status LCL (such as position, heading, etc.) and platform status PSTAT (such as position, velocity, acceleration, etc.) to the controller so the controller may calculate errors of the system from the reference trajectory RT.

The controller 305 generates control commands CC that will result in accurate tracking of the reference trajectory RT. These control commands CC are generated from a control policy, which is in turn generated from the reference trajectory RT. Most control system designs process the reference trajectory RT and synthesize a control policy online. Examples include model predictive control (MPC) and time-varying linear quadratic regulators (LQR).

When online control policy synthesis (i.e., generating a control policy from reference trajectory RT) is required, some time is needed to calculate a new policy for the most up-to-date reference trajectory from the planner, introducing latency in the system's reaction time.

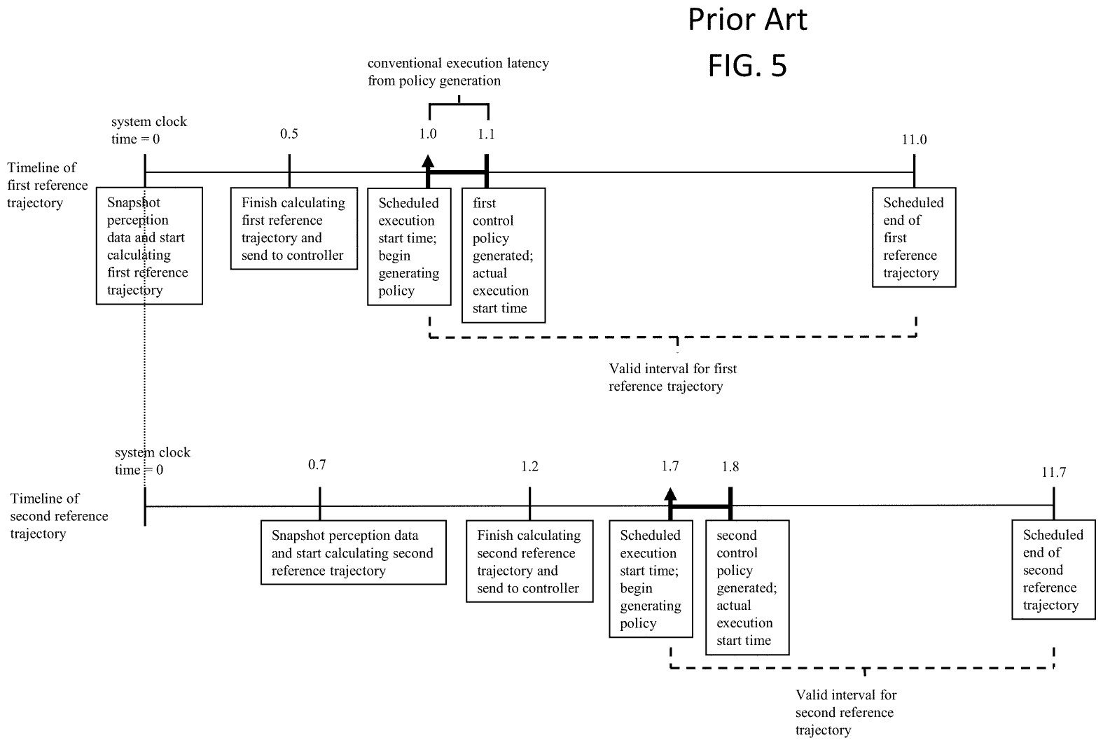

FIG. 5 illustrates how the timeline of reference trajectories and control policies generated in a conventional approach introduces latency. Starting from when the system clock has time t=0, a planner would snapshot perception data in a shared memory accessible to the planner and begin start calculating a first reference trajectory based on the perception data of time t=0. Snapshotting perception data may include copying perception data at a specific time from the shared memory into the planner's local memory.

The planner needs time to calculate the trajectory based on the perception data. In this example, the planner finishes calculating the first reference trajectory at time t=0.5, at which time it sends the first reference trajectory to the controller. Since it takes a non-deterministic time for a reference trajectory to be calculated, the first reference trajectory is scheduled to be valid at a future time, in this case time t=1.0, and end after a calculated interval, time t=11.0. For example, even though in this example it takes 0.5 units of time (where a unit of time may be, e.g., one second) to calculate the trajectory, it may take anywhere from 0.5 to 1.0 units of time for any given trajectory to be calculated. Setting the scheduled time 1 second after calculation begins ensures that the trajectory is ready at its scheduled valid interval. In this case, the first reference trajectory is considered a valid trajectory for the autonomous moving system to execute in the 10 units of time interval between time t=1.0 and time t=11.0.

In general, a trajectory starts being valid when, for example, the trajectory is a physical continuation of a previous trajectory. Since the trajectory is calculated from past perception data, a trajectory stops being valid after a calculated interval. After that point in time, another more up-to-date trajectory would presumably have already been calculated and be valid.

At time t=1.0, the controller recognizes that the first reference trajectory has become valid, and begins the process of executing the first reference trajectory. However, executing the reference trajectory requires generating a first control policy from the first reference trajectory, and then executing that first control policy. In this example, the controller takes 0.1 units of time to generate a control policy from the time it first recognizes the validity of the first reference trajectory.

Thus, in the conventional approach, since the controller waits until the trajectory becomes valid before generating the policy, there is a latency between when the is trajectory scheduled to be executed and when the trajectory is actually executed, based on the 0.1 units of time it takes the controller to generate the policy.

In this example, a second reference trajectory is calculated after the planner is finished calculating the first reference trajectory. At time t=0.7, the planner again snapshots perception data, which will have been updated from the perception data of time t=0, and begins calculating the second reference trajectory. The planner finishes calculating the second reference trajectory at time t=1.2, and sends the second reference trajectory to the controller. As with the first reference trajectory, since the time for calculating the trajectory is non-deterministic, and since the controller may have other operations to execute even when it has received the second reference trajectory, the second reference trajectory is scheduled to be valid at a later time than when it would otherwise be ready to execute in the controller, such as time t=1.7.

Overview of Embodiments of the Present Inventive Concept

In embodiments of the present inventive concept, once the controller 305 has received a reference trajectory, the controller 305 begins calculating the control policy immediately instead of waiting for that reference trajectory to become valid, removing the latency which results from delaying the generation of the control policy as described above.

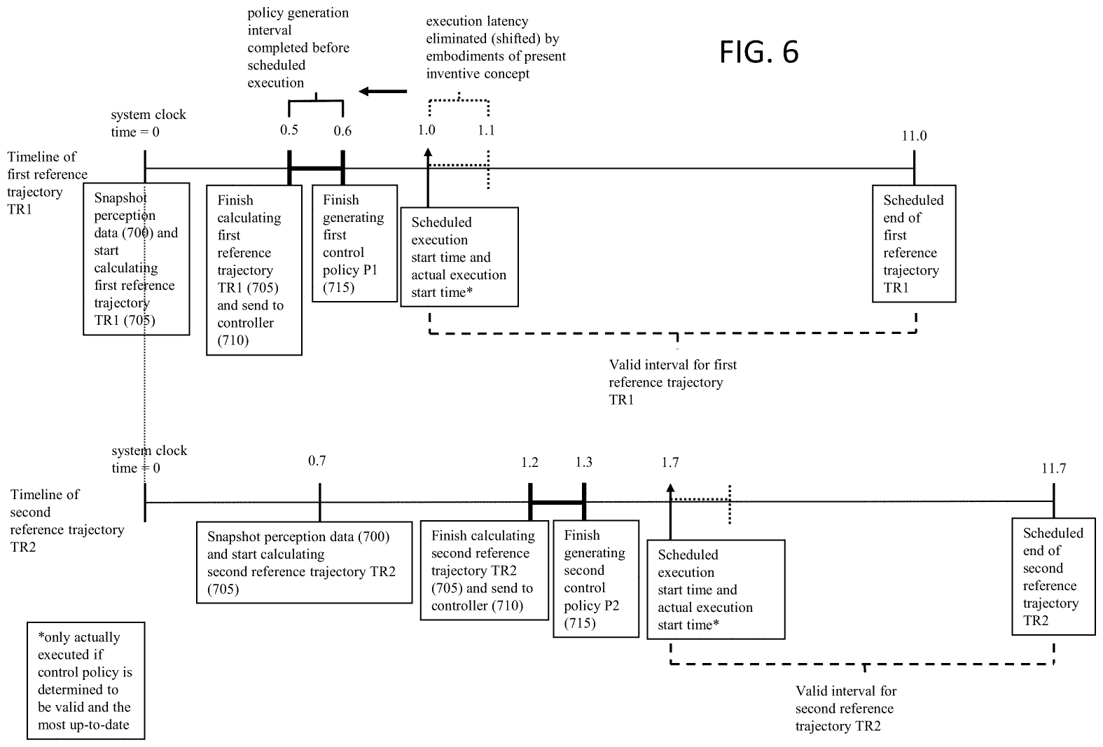

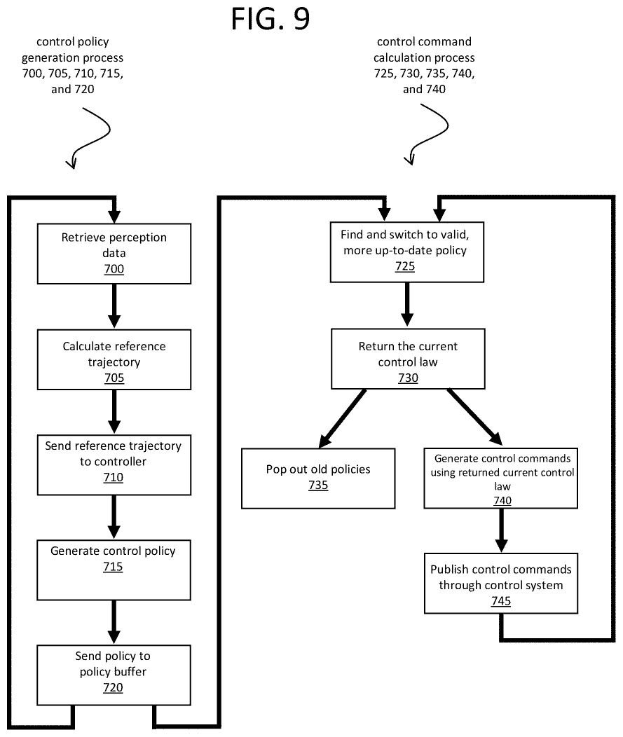

FIG. 6 illustrates the timeline of reference trajectories and control policies generated in an embodiment of the present inventive concept reducing and/or eliminating latency, with reference to step numbers from FIG. 9, which depicts, in part, steps corresponding to the timeline of FIG. 6.

Starting from a time t=0, the planner 304 would retrieve perception data. Retrieving perception data may include snapshotting perception data in a shared memory accessible to the planner 304, e.g., copying perception data from the shared memory into the planner 304's local memory. The planner 304 then begins calculating a first reference trajectory TR1 based on the perception data of time t=0.

The planner needs time to calculate the trajectory based on the perception data. In this example, the planner finishes calculating the first reference trajectory TR1 at time t=0.5, at which time it sends the first reference trajectory TR1 to the controller 305. Since it takes a non-deterministic time for a reference trajectory to be calculated, the first reference trajectory TR1 is scheduled to be valid at a future time accounting for the upper bound of this non-deterministic time, in this case time t=1.0, and scheduled to end after a calculated interval, time t=11.0. For example, even though in this example it takes 0.5 units of time to calculate the trajectory, it may take anywhere from 0.5 to 1.0 units of time for any given trajectory to be calculated. Setting the scheduled time 1 second after calculation begins ensures that the trajectory is ready at its scheduled valid interval. Here, the first reference trajectory TR1 is considered a valid trajectory for the autonomous moving system to execute in the 10 units of time interval between time t=1.0 and time t=11.0.

In general, a trajectory starts being valid when, for example, the trajectory is a physical continuation of a previous trajectory. Since the trajectory is calculated from perception data from a past time, a trajectory stops being valid after a calculated interval. After that point in time, another more up-to-date trajectory would presumably have already been calculated and would be valid.

After the planner 304 has finished calculating the first reference trajectory TR1, the planner 304 sends the first reference trajectory TR1 to the controller 305, which receives it at time t=0.5. At time t=0.5, the controller 305 starts generating the first control policy P1 from the first reference trajectory TR1. At time t=0.6, the controller has finished generating the first control policy P1 from the first reference trajectory. Thus, the 0.1 units of time latency which would result from generating the first control policy P1 at time t=1.0 is eliminated, since the generation of the first control policy P1 occurs at time t=0.5 instead, before the first reference trajectory TR1 is scheduled to be valid. In this case, when the first reference trajectory TR1 is valid at time t=1.0, the first reference trajectory TR1 is ready to be executed immediately, without that latency. In addition to the calculation time of the first reference trajectory TR1 being non-deterministic, the calculation time is also upper bounded so that if the first reference trajectory TR1 is finished being calculated before the upper bound is reached, the generation of the first control policy P1 may begin immediately, thus reducing latency. The scheduled execution time will take into account the upper bound on trajectory calculation time together with control policy generation.

In this example, a second reference trajectory TR2 is calculated after the planner 304 is finished calculating the first reference trajectory TR1. At time t=0.7, the planner 304 again snapshots perception data, which will have been updated from the perception data of time t=0, and begins calculating the second reference trajectory TR2. The planner 304 finishes calculating the second reference trajectory TR2 at time t=1.2, and sends the second reference trajectory TR2 to the controller. As with the first reference trajectory TR1, since the time for calculating the trajectory is non-deterministic, the second reference trajectory TR2 is scheduled to be valid at a later time than when it would otherwise be ready to execute in the controller 305, such as time t=1.7.

Also as with the first reference trajectory TR1, the controller 305 begins generating second control policy P2 right after receiving the second reference trajectory TR2 from the planner 304. The second control policy P2 is therefore ready for execution before the scheduled execution start time at t=1.7 for the second reference trajectory TR2.

Although in this example the planner finished calculating the first reference trajectory before the second reference trajectory, in other examples the planner might finish calculating the second reference trajectory after the first reference trajectory because of the non-deterministic nature of calculation. For example, the planner might take 1 unit of time from time t=0 to calculate the first reference trajectory such that the first reference trajectory is ready for execution only at time t=1, while the planner takes 0.5 units of time from time t=0.7 to calculate the second reference trajectory such that the second reference trajectory is ready for execution at time t=1.2.

Because it is preferable for the autonomous moving system 101 to execute a more-up-to-date reference trajectory, embodiments of the present inventive concept also include a control command calculation process that chooses the most up-to-date reference trajectory to execute, that runs parallel with as well as taking inputs from the control policy generation process.

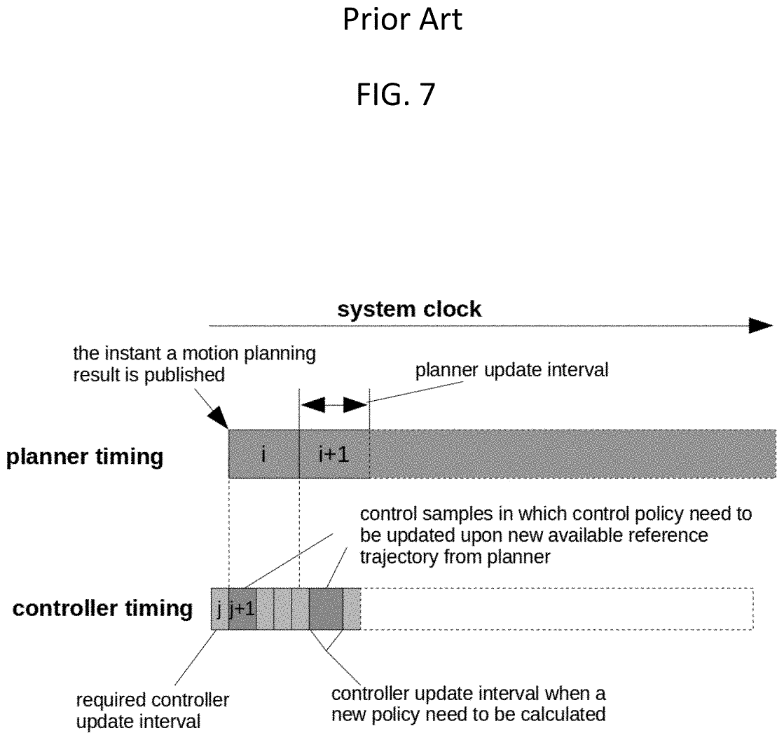

FIG. 7 depicts a timeline of reference trajectories and control policies generated in a conventional approach introducing latency. The intervals i and i+1 illustrate periods between reference trajectory updates from the planner 304. The interval j is the update time between control commands published to the control system 111. The interval j+1 represents the time required to compute the control policy for an updated reference trajectory, which introduces latency. Embodiments of the present inventive concept reduce and/or eliminate this latency.

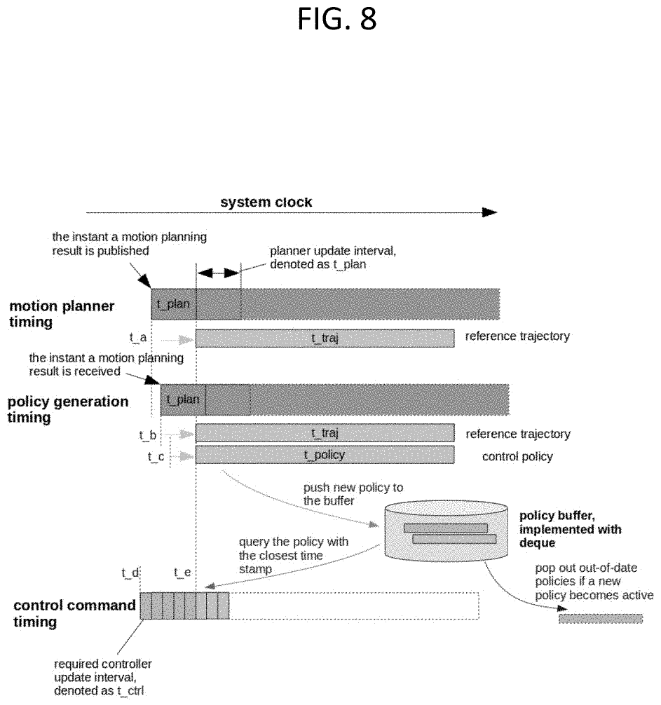

FIG. 8 illustrates a low-latency process of calculating and selecting up-to-date policies. The trajectory published at time t_a is intended to be executed over the interval t_traj which takes place in the future. This allows the control module time to construct the policy, completing the policy synthesis at time t_b and insert it into a policy buffer rather than a trajectory buffer. The latency reduction of this process may be, for example, 5 ms (t_b−t_c=5 ms).

FIG. 9 is a flow diagram illustrating a low-latency process of calculating and selecting up-to-date policies. Steps 700, 705, 710, 715, and 720 comprise the control policy generation process, while steps 725, 730, 735, 740, and 745 comprise the control command calculation process. These two processes run in parallel, and together make up the low-latency process of calculating and selecting up-to-date policies that makes up embodiments of the present inventive concept. Although FIG. 7 illustrates just one control policy generation process, it is to be understood that more than one control policy generation process may run in parallel with the control command calculation process, as detailed in the description of FIG. 6.

Since an example of the control policy generation process has already been described above with relation to FIG. 6, only a broad overview, with references to elements of FIGS. 3 and 4, will be provided here. At step 700, planner 304 retrieves perception data. At step 705, planner 304 calculates reference trajectory 313 based on the perception data. At step 710, the calculated reference trajectory 313 is sent to the controller 305. At step 715, controller 305 generates the control policy from the reference trajectory 313. At step 720, controller 305 sends the generated control policy to policy buffer 306 of controller 305. Once step 720 is completed, the control policy generation process starts again at step 700. The control policy generation process does not have to wait for the control command calculation process to finish before starting again.

Control policies sent to policy buffer 306 may be ordered according to the starting time of their execution. For example, policy buffer 306 may be a priority queue ordering the control policies within it. When control policies are generated, they are each pushed to the bottom of policy buffer 306, i.e., the back of the policy buffer 306, by the control policy generation process at step 720.

Each control policy contains a mapping from clock time and vehicle state to actions that are valid for a time interval corresponding to the valid time interval of the reference trajectory 313 from which the control policy was generated. The control policy enables the system to correct for errors in actual vehicle motion or position so that the vehicle can accurately track the reference trajectory that the control policy is generated from. A control policy is considered valid if the system clock time falls within the valid time interval of the control policy. As the system clock progresses, the number of valid control policies will increase, and all valid control policies will lie on the top of policy buffer 306 due to the ordering of the policy buffer 306.

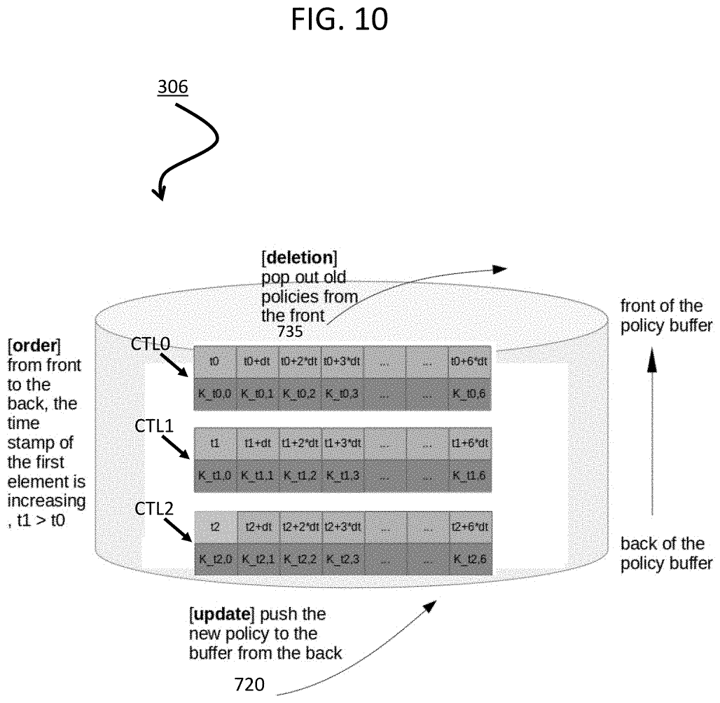

FIG. 10 is a block diagram illustrating an example of control policies CTL1, CTL2, and CTL3 in policy buffer 306 whose mappings are represented by lookup tables. Each control policy CTL1, CTL2, and CTL3 comprise a series of command laws K_tx,y (where x and y are integers) mapped to time tx+y*dt. In this example, control policy CTL3 is the control policy that has most recently been sent to policy buffer 306 from the control policy generation process, since it is at the back of policy buffer 306.

Referring back to FIG. 9, after step 720 of the control policy generation process, the control command calculation process begins at step 725, where controller 305 finds a valid and more up-to-date control policy than the current control policy. If a control policy in the policy buffer 306 is both a.) more up-to-date than the current control policy, and b.) the starting time of the more up-to-date control policy is less than or equal to the current time of the system clock, then the control command calculation process switches from the current control policy to the more-up-to-date control policy, from which the process will generate control commands. In some embodiments, the controller 305 reads policy buffer 306 starting from the front of policy buffer 306 to the back of policy buffer 306, and switches from the current control policy to the first control policy that meets the above criteria.

For example, suppose in FIG. 10 with three control policies CTL0, CTL1, and CTL2 in policy buffer 306, suppose respective starting times t0, t1, and t2 map to respectively increasing units of time on the system clock t0=0, t1=1, and t2=2. In this example, oldest control policy CTL0 is the current control policy from which control commands are generated. Newer control policy CTL1 was generated after current and oldest control policy CTL0 but was never switched to by the control command calculation process, and has been sitting in policy buffer 306 since the last cycle of the control policy generation process waiting to be either discarded or switched to in order to generate control commands. Newest control policy CTL2 has most recently been sent to the back of the policy buffer 306.

Controller 305 would determine that newer control policy CTL1 is more up-to-date than current and oldest control policy CTL0, but also that newest control policy CTL2 is more up-to-date than current and control policy CTL0. In this example, a control policy would be considered more up-to-date if it were closer to the back of policy buffer 306, i.e., having a later starting time than the other control policies. However, in other embodiments, a control policy would be considered more up-to-date even if it were closer to the front of policy buffer 306 compared to other control policies, but was based on perception data more recent (i.e., of a later system clock time) than those of the other control policies.

Because newer control policy CTL1 is more up-to-date than current and oldest control policy CTL0, controller 305 checks to see if newer control policy CTL1 is valid. In this example, assume the current system clock=1.5 units of time. Since (starting time t1=1 units of time is ≤current system clock=1.5 units of time), newer control policy CTL1 is valid. Therefore, controller 305 switches from executing current and oldest control policy CTL0 to executing newer control policy CTL1, which is the first valid control policy that is more-up-to-date than the current control policy CTL0.

In some instances, there would be no valid control policies other than the current control policy, i.e., all control policies in policy buffer 306 have starting times greater than the current system clock time. In those cases, the control command calculation process would proceed with executing the current control policy, without switching to another control policy.

Once a more up-to-date and valid control policy is switched to (if any), step 725 is complete. In step 730, the elements in the now-current control policy are read until the first element with a time greater than or equal to the current system clock time is found, and the corresponding control law is returned to controller 305. For example, if in the example of FIG. 10 newest control policy CTL1 has become the current control policy, current system clock=1.5 units of time, t1+1*dt=1.3 units of time, and t1+2*dt=1.6 units of time, then controller 305 would return control law K_t1,2 corresponding to t1+2*dt.

At step 740, using the above example, controller 305 would use returned control law K_t1,2 to generate the control command CC. For example, localization status LCL and/or platform status PSTAT may be input into returned control law K_t1,2 to generate control command CC. Meanwhile, at step 735, any old control policies, i.e., any control policies closer to the front of policy buffer 306 than the current control policy CTL1, such as oldest control policy CTL0, are discarded from policy buffer 306.

At step 745, the generated control command CC is published through the control system 111, so that the control system 111 may execute the control command CC through, for example, the steering, throttle, and braking units 201, 202, and 203. Control commands may include actions such as braking, accelerating, turning left, turning right, etc. that may be performed by an autonomous moving system.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A system comprising:
a processor; and
a memory coupled to the processor to store instructions, which when executed by the processor, cause the processor to perform operations, the operations including:
receiving perception data;
calculating a first reference trajectory based on the perception data, the first reference trajectory scheduled to be executed at a start time; and
generating, before the start time, a first control policy based on the first reference trajectory.

2. The system of claim 1, wherein the operations further comprise:
sending the first reference trajectory to a controller after calculating the first reference trajectory and before generating the first control policy; and
sending the first control policy to a policy buffer after generating the first control policy.

3. The system of claim 2, wherein the operations further comprise:
finding a more up-to-date control policy than an old active control policy in the policy buffer;
switching to the more up-to-date control policy so that the more up-to-date control policy becomes an active control policy and the old active control policy becomes inactive; and
deleting the old active control policy from the policy buffer.

4. The system of claim 3, wherein the operations further comprise:
returning, to the controller, a control law from the active control policy;
generating, with the controller, a control command from the returned control law; and
publishing the generated control command to a control system.

5. The system of claim 1, wherein the first reference trajectory is scheduled to be valid for a predetermined interval that is determined by the start time and an end time, and there is an interval of time between when the first control policy is generated and any point in time within the predetermined interval.

6. The system of claim 1, wherein:
the first reference trajectory is a scheduled trajectory for an autonomous vehicle indicating that the autonomous vehicle is to move from a first point to a second point of a path within a predetermined route within a predetermined interval,
a duration of the predetermined interval is determined by the start time and an end time.

7. The system of claim 2, wherein a planner retrieves the perception data, calculates the first reference trajectory, and sends the first reference trajectory to the controller; and
wherein the controller generates the first control policy and sends the first control policy to the policy buffer.

8. The system of claim 1, wherein perception data is first perception data and the operations further comprise:
obtaining a second control policy, comprising:
snapshotting second perception data at a different time than when the first perception data is retrieved;
calculating a second reference trajectory based on the second perception data, the second reference trajectory scheduled to be executed at a second start time; and
generating, before the second start time, a second control policy based on the second reference trajectory;
wherein obtaining a first control policy comprises retrieving a first perception data, calculating a first reference trajectory, and generating a first control policy; and
wherein obtaining a first control policy and obtaining a second control policy occurs concurrently for at least an interval of time.

9. A computer-implemented method for operating an autonomous moving system, the method comprising:
receiving perception data;
calculating a first reference trajectory based on the perception data, the first reference trajectory scheduled to be executed at a start time; and
generating, before the start time, a first control policy based on the first reference trajectory.

10. The computer-implemented method of claim 9, further comprising:
sending the first reference trajectory to a controller after calculating the first reference trajectory and before generating the first control policy; and
sending the first control policy to a policy buffer after generating the first control policy.

11. The computer-implemented method of claim 10, further comprising:
finding a more up-to-date control policy than an old active control policy in the policy buffer;
switching to the more up-to-date control policy so that the more up-to-date control policy becomes an active control policy and the old active control policy becomes inactive; and
deleting the old active control policy from the policy buffer.

12. The computer-implemented method of claim 11, further comprising:
returning, to the controller, a control law from the active control policy;
generating, with the controller, a control command from the returned control law; and
publishing the generated control command to a control system.

13. The computer-implemented method of claim 9, wherein the first reference trajectory is scheduled to be valid for a predetermined interval that is determined by the start time and an end time, and there is an interval of time between when the first control policy is generated and any point in time within the predetermined interval.

14. The computer-implemented method of claim 9, wherein:
the autonomous moving system is an autonomous vehicle;
the first reference trajectory is a scheduled trajectory for the autonomous vehicle indicating that the autonomous vehicle is to move from a first point to a second point of a path within a predetermined route within a predetermined interval,
a duration of the predetermined interval is determined by the start time and an end time.

15. The computer-implemented method of claim 10, wherein a planner retrieves the perception data, calculates the first reference trajectory, and sends the first reference trajectory to the controller; and
wherein the controller generates the first control policy and sends the first control policy to the policy buffer.

16. The computer-implemented method of claim 9, wherein perception data is first perception data, the method further comprising:
obtaining a second control policy, comprising:
snapshotting second perception data at a different time than when the first perception data is retrieved;
calculating a second reference trajectory based on the second perception data, the second reference trajectory scheduled to be executed at a second start time; and
generating, before the second start time, a second control policy based on the second reference trajectory;
wherein obtaining a first control policy comprises retrieving a first perception data, calculating a first reference trajectory, and generating a first control policy; and
wherein obtaining a first control policy and obtaining a second control policy occurs concurrently for at least an interval of time.

17. A non-transitory machine-readable medium having instructions stored therein, which when executed by a processor, cause the processor to perform operations, the operations comprising:
receiving perception data;
calculating a first reference trajectory based on the perception data, the first reference trajectory scheduled to be executed at a start time; and
generating, before the start time, a first control policy based on the first reference trajectory.

18. The non-transitory machine-readable medium of claim 17, the operations further comprising:
sending the first reference trajectory to a controller after calculating the first reference trajectory and before generating the first control policy;
sending the first control policy to a policy buffer after generating the first control policy;
finding a more up-to-date control policy than an old active control policy in the policy buffer;
switching to the more up-to-date control policy so that the more up-to-date control policy becomes an active control policy and the old active control policy becomes inactive;
deleting the old active control policy from the policy buffer;
returning, to the controller, a control law from the active control policy;
generating, with the controller, a control command from the returned control law; and
publishing the generated control command to a control system.

19. The computer-implemented method of claim 18, wherein the first reference trajectory is scheduled to be valid for a predetermined interval that is determined by the start time and an end time, and there is an interval of time between when the first control policy is generated and any point in time within the predetermined interval.

20. The computer-implemented method of claim 17, wherein:
the first reference trajectory is a scheduled trajectory for an autonomous vehicle indicating that the autonomous vehicle is to move from a first point to a second point of a path within a predetermined route within a predetermined interval,
a duration of the predetermined interval is determined by the start time and an end time.
